(19) United States
(12) Patent Application Publication
(10) Pub. No.: US 2017/0370134 A1
(43) Pub. Date: Dec. 28, 2017

(54) CAR DOOR SWING CONTROL

(71) Applicant: Panasonic Automotive Systems Company of America, Division of Panasonic Corporation of North America, Peachtree City, GA (US)

(72) Inventors: J. Scott SIEGEL, Rochester Hills, MI (US); Padmanaban KANAGARAJ, Farmington Hills, MI (US)

(73) Assignee: Panasonic Automotive Systems Company of America, Division of Panasonic Corporation of North America

(21) Appl. No.: 15/623,136

(22) Filed: Jun. 14, 2017

Related U.S. Application Data
(60) Provisional application No. 62/353,520, filed on Jun. 22, 2016.

(51) Int. Cl. E05C 17/00; E05F 5/10

(52) U.S. Cl. CPC E05C 17/003; E05F 5/10; E05Y 2900/531

(57) ABSTRACT

A motor vehicle includes a body and a door pivotably attached to the body. A stop mechanism limits the pivoting of the door to an angular range. The stop mechanism is adjustable by a user such that the user may define the angular range to which the pivoting of the door is limited.

### CROSS-REFERENCED TO RELATED APPLICATIONS

This application claims benefit of U.S. Provisional Application No. 62/353,520 filed on Jun. 22, 2016, which the disclosure of which is hereby incorporated by reference in its entirety for all purposes.

### FIELD OF THE INVENTION

The disclosure relates to a door opening mechanism in a motor vehicle.

### BACKGROUND OF THE INVENTION

It is a common problem that a car door cannot be opened in an easily controllable manner, particularly when the force of wind pushes the door farther open after the door has begun to open. This often results in a passenger being unable to limit how far the door swings open, and the door may hit other objects, such as an adjacent parked car or shopping cart, or the door may even bit a person. Although vehicle doors include stop mechanisms, the stop mechanisms only stop the doors when they are fully open.

### SUMMARY

The present invention may provide a device that limits the cars door's swing anywhere between a fully open position to a fully closed position dependent upon when the user decides to use it. In one embodiment, the invention includes an electronically adjustable stop mechanism which enables the user to selectively limit how far the door may open. For example, if the door normally pivots 80 degrees from a closed position to a fully open position, the user may selectively limit the range of pivoting of the door when opening to a discrete value of 30 degrees, 50 degrees, or 70 degrees. Alternatively, the user may select any door pivoting range value between zero degrees and 80 degrees.

In another embodiment, the invention allows the door to open fully, but enables the user to select a level of constant braking force to be applied to the door as it opens. For example, the user may select between an additional 5 pounds, 10 pounds or 15 pounds of force being required to push open the door. Thus, the additional resistive force may enable the user to more easily control how far and how quickly the door opens.

In yet another embodiment, the invention allows the door to open fully, but enables the user to select a level of braking force to be applied to the door, wherein the level of braking force continuously increases as the door pivots farther open. For example, the user may select between the resistive force continuously increasing from one pound at the closed position to 10 pounds at the fully open position; the resistive force continuously increasing from five pounds at the Closed position to 15 pounds at the fully open position; or the resistive force continuously increasing from 10 pounds at the closed position to 20 pounds at the fully open position. Thus, the user may more easily, control how far and how quickly the door opens, particularly near the fully open position. In one embodiment, the level of braking force not only continuously increases as the door pivots farther open, but also increases asymptotically or increases parabolically as the door pivots farther open. For example, the resistive force may continuously and parabolically increase from 10 pounds at the closed position, to 20 pounds at a position half way between the closed position and the fully open position, and 100 pounds at the fully open position. Thus, as the door get closer to the fully open position, which presents the most danger, opening the door further becomes much more difficult. A dampening element may provide the resistive force.

In one embodiment, the invention comprises a motor vehicle including a body and a door pivotably attached to the body. A stop mechanism limits the pivoting of the door to an angular range. The stop mechanism is adjustable by a user such that the user may define the angular range to which the pivoting of the door is limited.

In another embodiment, the invention comprises a motor vehicle including a body and a door attached to the body such that the door is pivotable between a closed position and an open position. A dampening element is coupled between the body and the door. The dampening element provides mechanical resistance to the pivoting of the door from the closed position to the open position.

In yet another embodiment, the invention comprises a motor vehicle including a body and a door attached to the body such that the door is pivotable between a closed position and an open position. A dampening element is coupled between the body and the door. The dampening element provides an increasing level of mechanical resistance to the pivoting of the door as the door is pivoted from the closed position to the open position.

An advantage of the present invention is that it may enable a user to more easily control or limit the opening of a vehicle door.

### BRIEF DESCRIPTION OF THE DRAWINGS

A better understanding of the present invention will be had upon reference to the following description in conjunction with the accompanying drawings.

FIG. 1 is a schematic diagram of one example embodiment of a car door swing control arrangement of the present invention.

FIG. 2 is a schematic view of one embodiment of a control device which a user may use to control the car door swing control arrangement of FIG. 1.

FIG. 3 is a schematic diagram of one example embodiment of a dampening apparatus which may be included in the car door swing control arrangement of FIG. 1.

FIG. 4 is a schematic view of one embodiment of a control device which a user may use to control the dampening apparatus of FIG. 3.

### DETAILED DESCRIPTION OF THE PREFERRED EMBODIMENTS

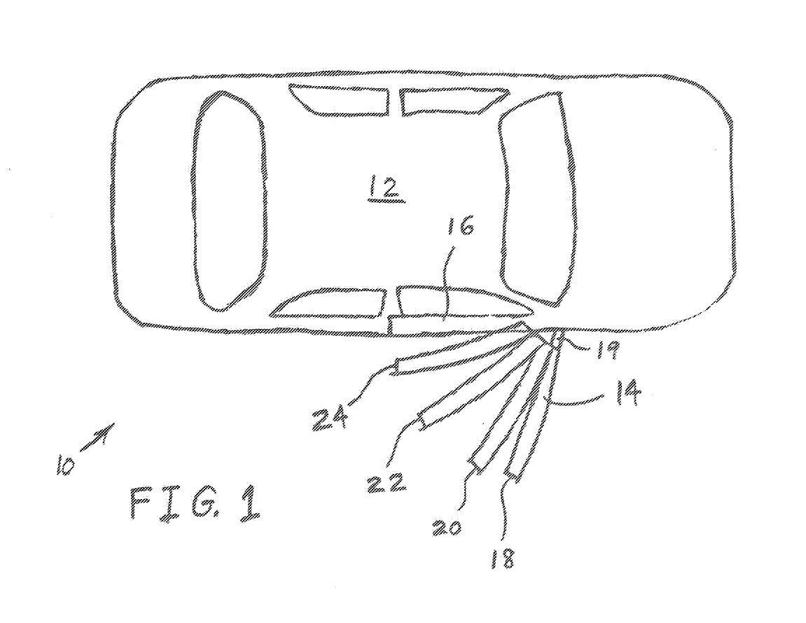

FIG. 1 illustrates one embodiment of a car door swing control arrangement 10 of the present invention, including a vehicle 12 having a door 14 which may pivot about 80 degrees between a closed position 16 and a fully open position 18. A door stop 19, which is only schematically indicated in FIG. 1, may be in position to limit the opening of door 14 to the fully open position 18. According to the invention, the position of the door stop may be selectively adjustable so that the door stop may limit the opening of door 14 to any of the semi-open positions indicated at 20, 22 and 24. The door may be pivotable within a range of about 70 degrees, 50 degrees, and 30 degrees, respectively, in positions 20, 22 and 24. The position of door stop 19 may be movable mechanically and/or hydraulically, and may be controlled by the user via an electrical or electronic control device within the passenger compartment.

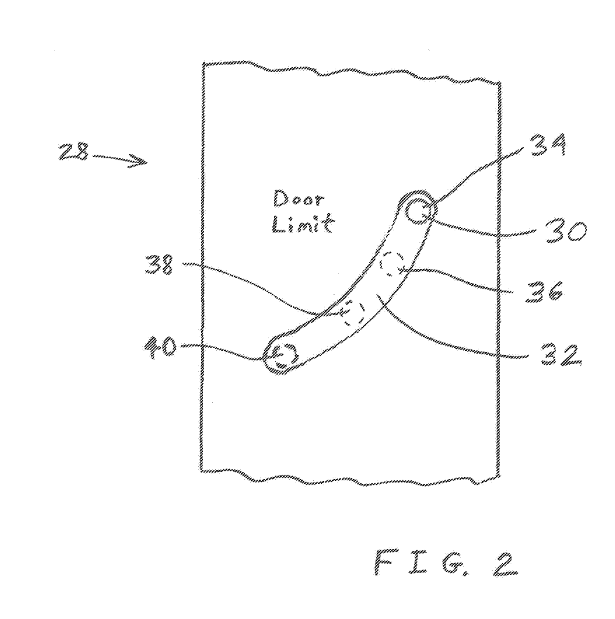

FIG. 2 is a schematic view of one embodiment of an electrical or electronic control device 28 which a user may use to control the car door swing control arrangement of FIG. 1. The control device includes a pin 30 disposed in an arcuate slot 32 representing the path of the outer edge of ear door 14 as the door opens. With pin 30 in the position 34 at the outer end of slot 32, the position of door stop 19 may be such that door 14 can be opened to the fully open position 18. However, if pin 30 is moved to position 36, the position of door stop 19 may also be caused to move such that the opening of door 14 is limited to the semi-open position indicated at 20. Similarly, if pin 30 is moved to position 38, the position of door stop 19 may also be caused to move such that the opening of door 14 is limited to the semi-open position indicated at 22; and if pin 30 is moved to position 40, the position of door stop 19 may also be caused to move such that the opening of door 14 is limited to the semi-open position indicated at 24.

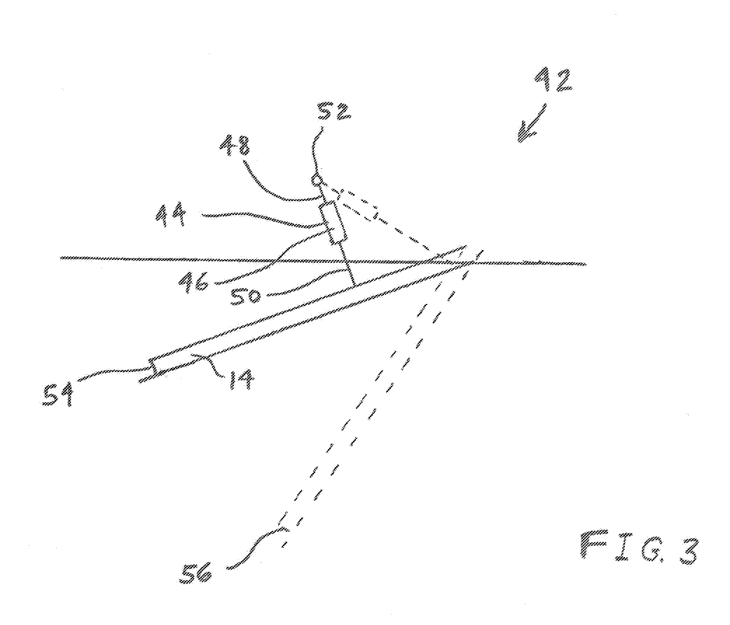

FIG. 3 illustrates one example embodiment of a dampening apparatus 42 which may be included in the car door swing control arrangement 10 of FIG. 1. Dampening apparatus 42 includes a dampening element 44 which may be similar to a shock absorber. Dampening element 44 includes a hydraulic cylinder 46 having a fixed rod 48 extending from a first end of cylinder 46, and a slidable rod 50 extending from a second end of cylinder 46. An outer end of rod 48 is pivotably attached to a fixed structure 52, and an outer end of rod 50 is slidingly coupled to car door 14. As door 14 further opens from the position indicated at 54 to the position indicated at 56, rod 50 slides out of cylinder 46, and the outer end of rod 50 slides along the length of door 14.

Dampening element 44 may provide resistance or a dampening force that resists the force with which the user pushes on door 14 in order to open door 14. Thus, the user is required to exert more force on door 14 in order to open the door, which may enable the user to better control how far the door opens. In one embodiment, dampening element 44 applies a constant level of resistance to the opening of door, regardless of how far the door has already been opened. In another embodiment, dampening element 44 applies an increasing level of resistance as door 14 opens farther, thus providing the user with an increased level of control on the door as the door approaches the limit of how far it can open, which is where the door is also most likely to collide with another object. In yet another embodiment, dampening element 44 applies not only an increasing level of resistance as door 14 opens farther, but applies an asymptotically increasing or parabolically increasing level of resistance as door 14 opens farther.

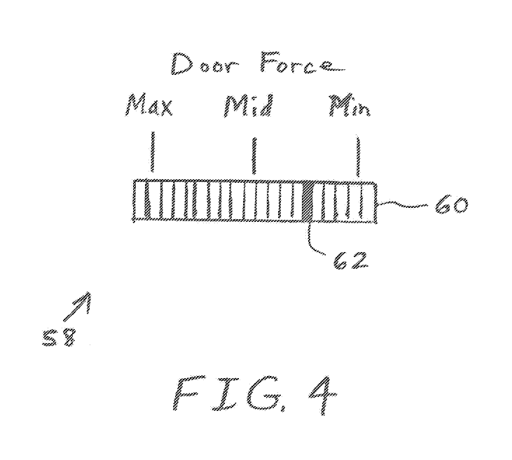

FIG. 4 is a schematic view of one embodiment of a control device 58 which a user may use to control the dampening apparatus of FIG. 3. Control device 58 may include a dial 60 having an indicator 62 which may be rotated to a maximum force position, a minimum force position, or any position in-between. The position of dial 60 may control a hydraulic pump (not shown) which pumps hydraulic fluid into or out of hydraulic cylinder 46, and thereby affects the level of resistive force that dampening element 44 exerts on door 14.

A vehicle may include the dooring limiting apparatus of FIGS. 1-2 without the dampening apparatus of FIGS. 3-4; may include the dampening apparatus of FIGS. 3-4 without the dooring limiting apparatus of FIGS. 1-2; or may include both the dooring limiting apparatus of FIGS. 1-2 and the dampening apparatus of FIGS. 3-4.

The invention may be disabled in the event of a user pressing a panic button (not shown) within a vehicle passenger compartment; an air bag deployment; a moisture sensor that is shielded from rain and road spray detecting that the vehicle is under water; or a heat sensor detecting that the vehicle is in a fire. In case of such disablement, door 14 may be opened as freely as if car door swing control arrangement 10 were not in place.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a body;
a door pivotably attached to the body; and
a stop mechanism configured to limit the pivoting of the door to an angular range, the stop mechanism being adjustable by a user such that the user may define the angular range to which the pivoting of the door is limited.

2. The motor vehicle of claim 1 wherein the door is configured to pivot relative to the body.

3. The motor vehicle of claim 1 wherein the angular range is approximately between 20 degrees and 80 degrees.

4. The motor vehicle of claim wherein the door is closed at one end of the range,

5. The motor vehicle of claim 1 further comprising an electronic, control device by which the user may define the angular range to which the pivoting of the door is limited.

6. The arrangement of claim 5 wherein the electronic control device includes a pin that is movable within an arcuate slot.

7. The arrangement of claim 5 wherein the electronic control device is electrically connected to a motor that drives the stop mechanism.

8. A motor vehicle, comprising:
a body;
a door attached to the body such that the door is pivotable between a closed position and an open position; and
a dampening element coupled between the body and the door, the dampening element being configured to provide mechanical resistance to the pivoting of the door from the closed position to the open position.

9. The motor vehicle of claim 8 wherein the door is configured to pivot relative to the body.

10. The motor vehicle of claim 8 wherein the door pivots approximately between 20 degrees and 80 degrees between the closed position and the open position.

11. The motor vehicle of claim 8 wherein the dampening element comprises a shock absorber.

12. The motor vehicle of claim 8 wherein the dampening element is configured to provide a substantially constant level of mechanical resistance to the pivoting of the door from the closed position to the open position.

13. The motor vehicle of claim 8 wherein the dampening element is configured to provide substantially no mechanical resistance to the pivoting of the door from the open position to the closed position.

14. The motor vehicle of claim 8 further comprising an electronic control device by which the user may control a level of the mechanical resistance to the pivoting of the door from the closed position to the open position.

15. The motor vehicle of claim 14 wherein the electronic control device includes a rotatable dial.

16. The motor vehicle of claim 14 wherein the electronic control device is electrically connected to a hydraulic pump that is configured to pump hydraulic fluid into and/or out of the dampening element.

17. A motor vehicle, comprising:
a body;
a door attached to the body such that the door is pivotable between a closed position and an open position; and
a dampening element coupled between the body and the door, the dampening element being configured to provide an increasing level of mechanical resistance to the pivoting of the door as the door is pivoted from the closed position to the open position.

18. The motor vehicle of claim 17 wherein the dampening element is configured to provide substantially no mechanical resistance to the pivoting of the door from the open position to the closed position.

19. The motor vehicle of claim 17 further comprising an electronic control device by which the user may control the level of the mechanical resistance to the pivoting of the door from the closed position to the open position.

20. The motor vehicle of claim 19 wherein the electronic control device is electrically connected to a hydraulic pump that is configured to pump hydraulic fluid into and/or out of the dampening element.
